(19) United States
(12) Patent Application Publication
(10) Pub. No.: US 2007/0042647 A1
(43) Pub. Date: Feb. 22, 2007

(54) Blade-type electronic device

(75) Inventor: Chih-Peng Chuang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/373,032

(22) Filed: Mar. 10, 2006

(30) Foreign Application Priority Data
Aug. 17, 2005 (TW) 094214054

(51) Int. Cl. H01R 13/68

(52) U.S. Cl. 439/620.29

(57) ABSTRACT

The present invention provides a blade-type electronic device, including a blade-type body; a handle provided on one side of the blade-type body to assist the installation of the blade-type electronic device; a connector disposed on one side of the blade-type body to provide electrical connection with an external device; and a switch disposed inside of the blade-type body and electrically connected to the connector to switch on/off electric signals of the blade-type body, the switch being able to be turned on when the handle is in an installed position.

### BACKGROUND OF THE INVENTION

1. Field of the Invention

The present invention relates generally to electronic devices, and more particularly, to a blade-type electronic device that is particularly applicable to computing systems including blade server systems.

2. Description of the Related Art

Deployment and integration of long-distance information become crucial for enterprises as a result of global economy development and wide application of enterprise information. Electronic equipment such as servers that are often used in network environment employ a server-control mode to achieve the objectives of collection and management of data and information, as the server management is known to have characteristics that can satisfy the demands of high security, wide bandwidth, high system performance and system expansion flexibility at low cost for information maintenance.

In conventional server management, a cluster of server modules is disposed in a machine cabinet, each of the plurality of servers requires its own set of independent equipment including a power cable, Ethernet interface, system management interface, power supply interface, keyboard/display/mouse interfaces, and optical fiber exchange interfaces, and so forth, adversely necessitating a great number of cables to be disposed in the cabinet. Such server configuration has many drawbacks that include difficulties in rapidly solving the problems when encountered, and inconveniences in installation and replacement of new servers when needed. Moreover, the individual power supply and switching unit for each server also takes up a lot of space in the cabinet. In light of the above, a so-called blade server has been developed to eliminate and improve on the foregoing drawbacks.

Blade servers are a relatively new technology that provides for a more compact server system. Blade servers are smaller than traditional rack-mounted or upright-standing servers in size, and are different from the rack-mounted servers in particular that the plurality of the independent server are slimmed and integrated into individual blade-type electronic devices that highly integrate Central Processor Units (CPUs), hard drives, memories, network interfaces and control chips. The casings of these blade-type electronic devices, similar to detachable cards of various kinds disposed in a computer mainframe, are inserted side-by-side into the rear board of a blade server, allowing them to share the aforementioned equipment, such as the power supply, fan, mouse, keyboard and display interfaces collectively. The integration and application of these blade-type electronic devices occupy relatively less space than conventional vertical-type or racked-type servers and thus has less connecting circuits, which is an advantage to facilitate management.

In addition, a blade-type interface device capable of integrating interface modules, for example, peripheral component interconnect (PCI) cards, is developed and provided by the inventor of the present invention. Thus, provision of blade-type electronic device has enabled wider application of the blade server integrating the foregoing components, capable of executing and performing multiple applications that bring forth beneficial results of modularized algorithm and simulation.

In a conventional method of assembling a blade-type electronic device, the blade-type casing and the blade body integrating the CPU, memories, network interfaces, control chips, or interface modules are first inserted into a slide rail; then, a handle disposed on one side of the body for facilitating assembly is pushed towards the direction of the blade body to actuate a hooking portion provided at one end of the handle for engaging with an opening or protruding portion disposed on the slide rail, whereby a connector disposed at one end of the blade body is precisely inserted into the connector of a server mainframe.

However, this conventional way of electrical connection turns out to be disadvantageous when in use. For example, when the connector of the blade body is correspondingly inserted into the connector of the server mainframe, the two connectors may already be electrically connected to each other, i.e. the system is in operation, however, a user cannot know for sure if the system is in operation if the user has not executed any system function. If the user unknowingly pulls out the blade-type electronic device when the system is in operation, it may lead to a system crash and even cause serious damage to the system as a result.

Accordingly, needs exist for developing a hot-swappable blade-type electronic device such that a user can be aware of the operational status of the system and safely uses the device accordingly.

### SUMMARY OF THE INVENTION

In light of the drawbacks above, the primary objective of the present invention is to provide a hot-swappable blade-type electronic device.

Another objective of the present invention is to provide a blade-type electronic device enabling users to identify system operational status and accordingly use the device safely.

In accordance with the above and other objectives, a blade-type electronic device proposed by the present invention comprises: a blade-type body; a handle provided on one side of the blade-type body to assist installation of the blade-type electronic device; a connector disposed on one side of the blade-type body to provide electrical connection; and a switch disposed inside of the blade-type body and electrically connected to the connector to switch on/off electric signals of the blade-type body, the switch being able to be turned on when the handle is in an installed position.

In one preferred embodiment, the blade-type body may include a blade-type casing, an adapter card and an electronic unit, wherein the adapter card may be disposed on one side of the blade-type casing, and the electronic unit may be, for example, disposed in the inside of the blade-type casing and can be electrically connected to the adapter card. The blade-type body may further include a first wedging portion, whereas the handle may include a second wedging portion to engage correspondingly with the first wedging portion when the handle is in the installed position. In addition, the handle may optionally include a hooking portion and an actuator for actuating the switch, whereas the switch may include an electrical connector and a switch actuator, the electrical connector being disposed inside of the blade-type body and the switch actuator is fastened at a position inside the front of the blade-type body that can be physically actuated by the handle when in the installed position.

Compared to prior art techniques, the present invention requires only provision of a controlling switch that is compliant with the existing structure, thereby allowing a user to connect or disconnect the blade-type electronic device without turning off power. Thus, the present invention offers advantages over prior art in that it is hot-swappable to prevent incidents of a computer crash or damages to the system due to user's ignorance. Moreover, the user can be aware of the system operational status such that the user can operate and use the device safely.

In order to provide a further understanding of the invention, the following detailed description illustrates embodiments and examples of the invention, it should be understood that this detailed description is provided only for illustration of the invention and not to be construed as limitation to the scope of the present invention.

### BRIEF DESCRIPTION OF THE DRAWINGS

The drawings included herein provide a further understanding of the invention. A brief introduction of the drawings is as follows:

FIG. 1A is a schematic view showing a partial structure of a preferred embodiment of the blade-type electronic device according to the present invention;

FIG. 1B is a perspective view of the preferred embodiment of the blade-type electronic device according to the present invention;

FIG. 2 is a schematic view showing another partial structure of the preferred embodiment of a blade-type electronic device according to the present invention;

FIGS. 3A to 3D are schematic views showing the structure of a switch as depicted in FIG. 1A from various angles.

FIGS. 4 and 5 are both schematic views showing the installation of the blade-type electronic device in a blade server system, wherein FIG. 4 shows the status of the blade-type electronic device before installation, and FIG. 5 shows the status of the blade-type electronic device after installation in a blade server system.

### DETAILED DESCRIPTION OF THE PREFERRED EMBODIMENTS

The aspects described herein are merely a few of several that can be achieved by using the present invention. The following descriptions do not suggest, however, that the invention must be used only in certain manners to attain the foregoing aspects. These and other features and aspects of the present invention will be more fully understood from the following detailed description of the preferred embodiments, which should be read in light of the accompanying drawings. It should also be understood that both the foregoing generalized description and the following detailed description are exemplary, and are not restrictive of the invention.

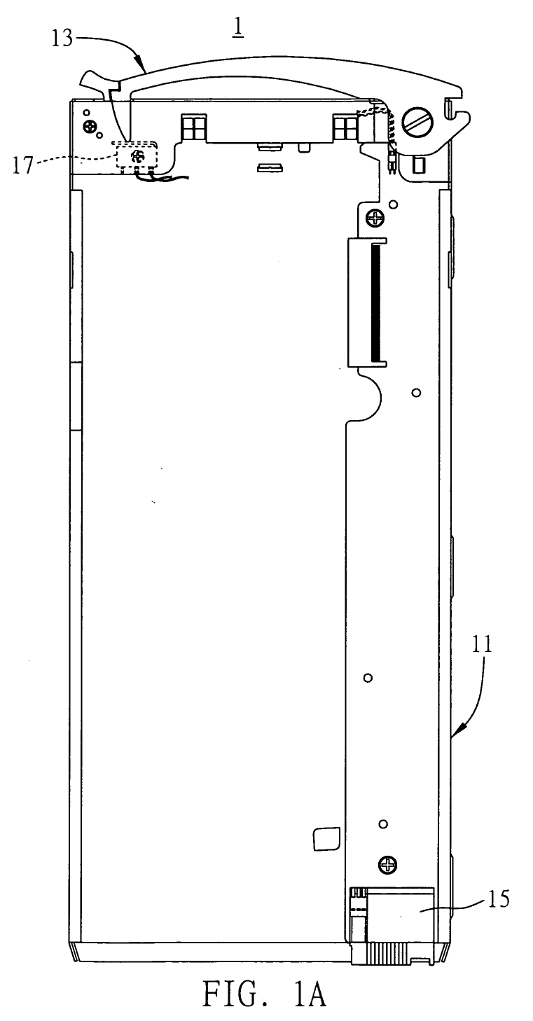

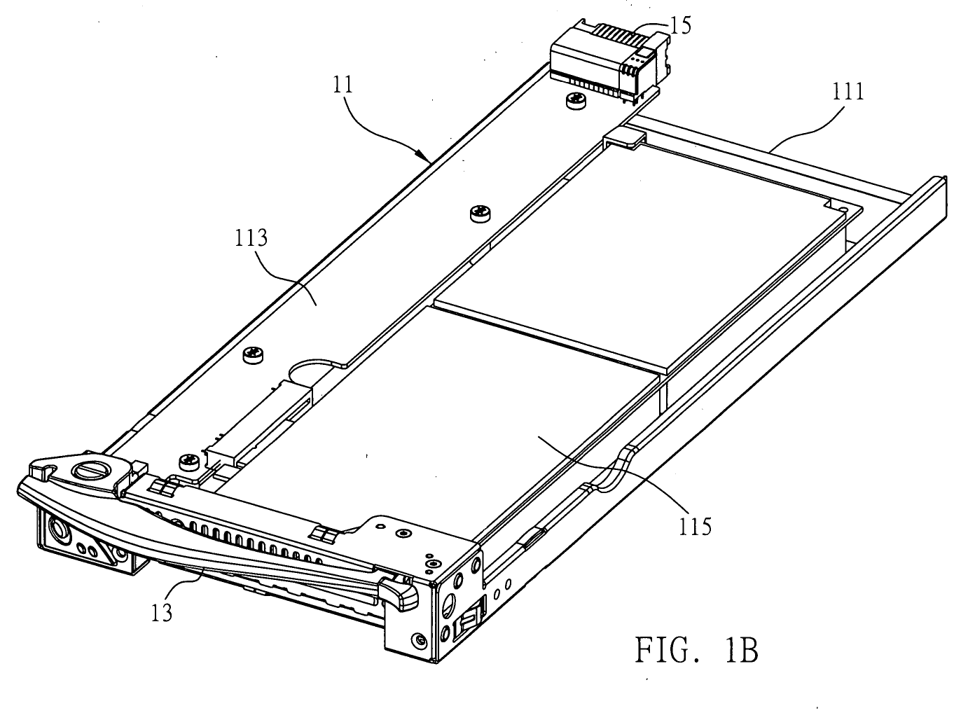

FIGS. 1A through 5 are schematic views in accordance with preferred embodiments of the present invention. Referring to FIG. 1A in cooperation with FIG. 1B, the blade-type electronic device 1 of the invention comprises: a blade-type body 11; a handle 13 disposed on one side of the blade-type body 11; a connector 15 disposed on one side of the blade-type body 11; and a switch 17 that can be disposed inside of the blade-type body 11 and electrically connect to the connector 15 to control by switching on/off electric signals of the blade-type body 11.

As shown in FIG. 1B, the blade-type body 11 may include a blade-type casing 111, an adapter card 113 disposed on one side of the blade-type casing 111, and an electronic unit 115 installed inside of the blade-type casing 111 and can electrically connect with the adapter card 113. The blade-type casing 111 can be one of the casings of a blade server (not shown), and the adapter card 113 can be a circuit board. In the following embodiments, the blade-type body 11 equipped with the blade-type casing 111 and the electronic unit 15 integrating with CPU, hard drive, memory, network interfaces, control chips and interface modules therein are described for illustration purpose only; the present invention is not limited to these specific details.

For the purposes of clarity and brevity, only parts and structures in direct relation to the invention are shown in the drawings, in particular, the portion associated with the electronic unit 115 of the blade-type body 11 is purposely omitted from the drawings except for FIG. 1B.

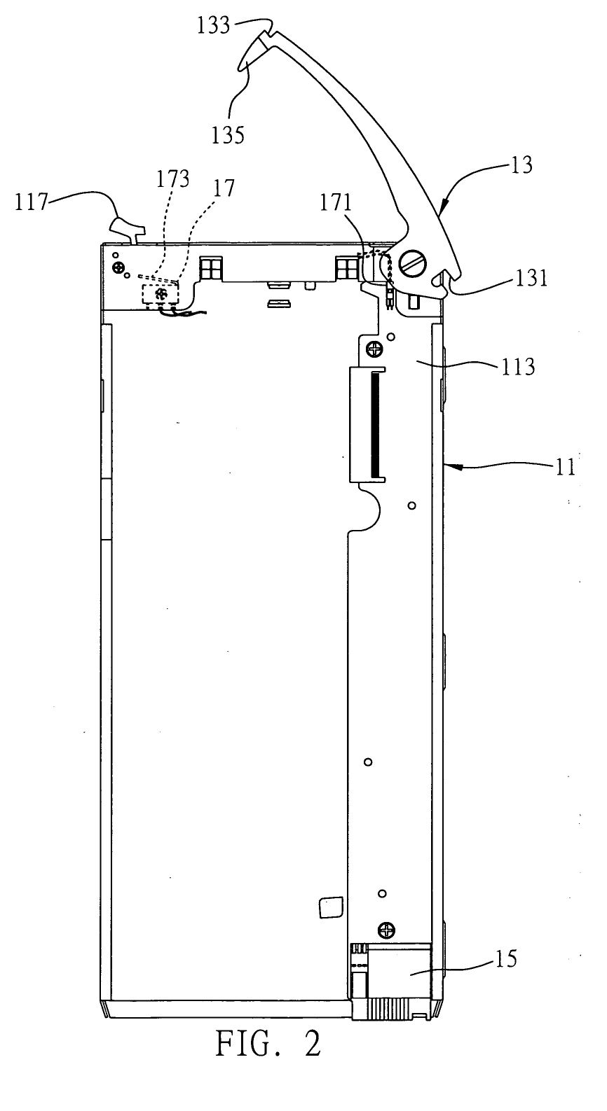

Referring to FIG. 1A in cooperation to FIG. 2, in this embodiment, the handle may be disposed on the front side of the blade-type body 11, comprising a hooking portion 131 provided at one end for the handle 13 to actuate an opening or a protruding portion (not shown) disposed on the slide rail of the server mainframe and a second wedging portion 133 to match correspondingly to a first wedging portion 117 disposed on the front side of the blade-type body 11, and an actuator 135 adapted to actuate the switch 17. Accordingly, the blade-type body 11 can be fastened to the server mainframe and the switch be properly actuated by pushing the handle 13.

The handle 13 may well be an ordinary handle being installed on the blade-type body 11 for assisting the assembly of the blade-type electronic device 1. Note that the structure of the handle 13 is an example but not limited to that disclosed in the preferred embodiment. Other structures may apply so long as it allows the connector 15 to be correspondingly connected with the connector of the server mainframe (not shown) and allows the switch 17 to be actuated.

As shown in FIG. 1A, the connector 15 is disposed at a rear side of the blade-type body 11 to provide electrical connection. In this embodiment, the connector 15 may electrically connect with the connector disposed on a rear board (not shown) of the server mainframe to thereby start the system operation. Since techniques of the electrical connection between the connector 15 and an external device and the electrical connection between the connector 15 and the rear board (not shown) of the server mainframe are well-known in the art, thus they will not be further detailed herein.

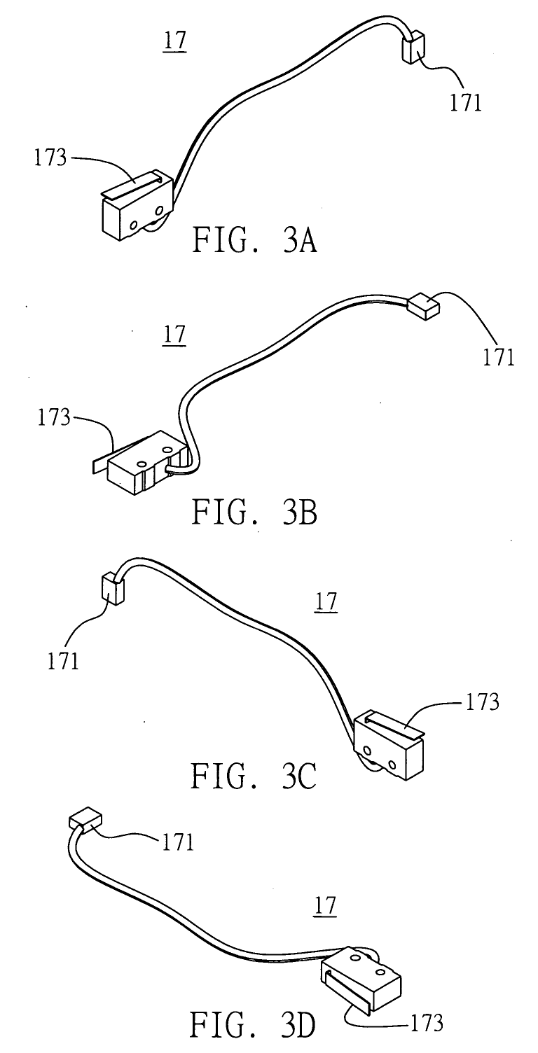

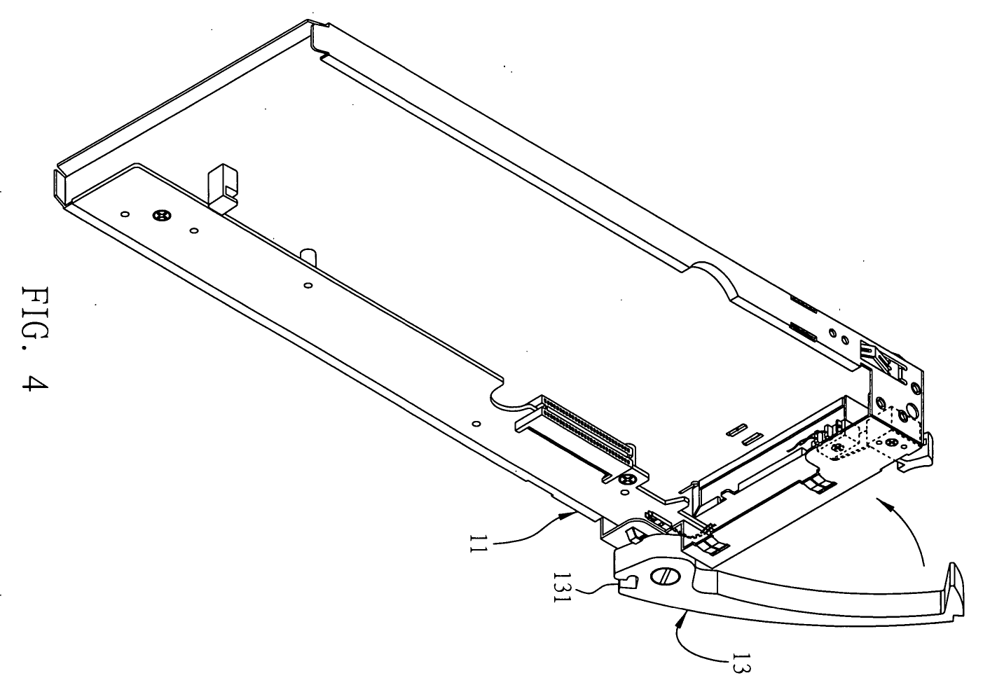

Referring to FIG. 2 with respect to FIGS. 3A to 3D, the switch 17 can be actuated with setting of the handle 13 and basically comprises an electrical connector 171 and a switch actuator 173. The electrical connector 171 can be, for example, disposed inside of the blade-type body 11 to electrically connect with the connector 15 via the adapter card 113, thereby electrically connecting the connector 15 to a rear board of a server mainframe. The switch actuator 173 can be selectively fastened inside the front of the blade-type body 11 near the first wedging portion 117, so that when the handle 13 is pushed into the blade-type body 11 for assisting assembly, the actuator 135 is actuated so as to control on/off of electrical signals of the blade-type body 11.

Alternatively, one may utilize other forms of switches in other preferred embodiments, so long as the switch can electrically connect the connector 15 to control the on/off electrical, signals of the blade-type body 11. Further, while in this embodiment the electrical connector 171 is connected to the adapter card 113 and the switch actuator 173 is fastened inside the front of the blade-type body 11, as shown in FIG. 2, the disposal means and position of the electrical connector 171 and the switch actuator 173 are of design choices and are not intended as limitations.

In operating the switch 17 to electrically connect with the connector 15 to switch on/off electrical signals of the blade-type body 11, as shown in FIG. 4, the handle 13 is first pushed towards the front end of the blade-type body 11 such that the hooking portion 131 disposed on one end of the handle 13 is actuated to engage with the opening or the protruding portion on the slide rail of the mainframe server, thereby the blade-type body 11 is fastened onto the mainframe server.

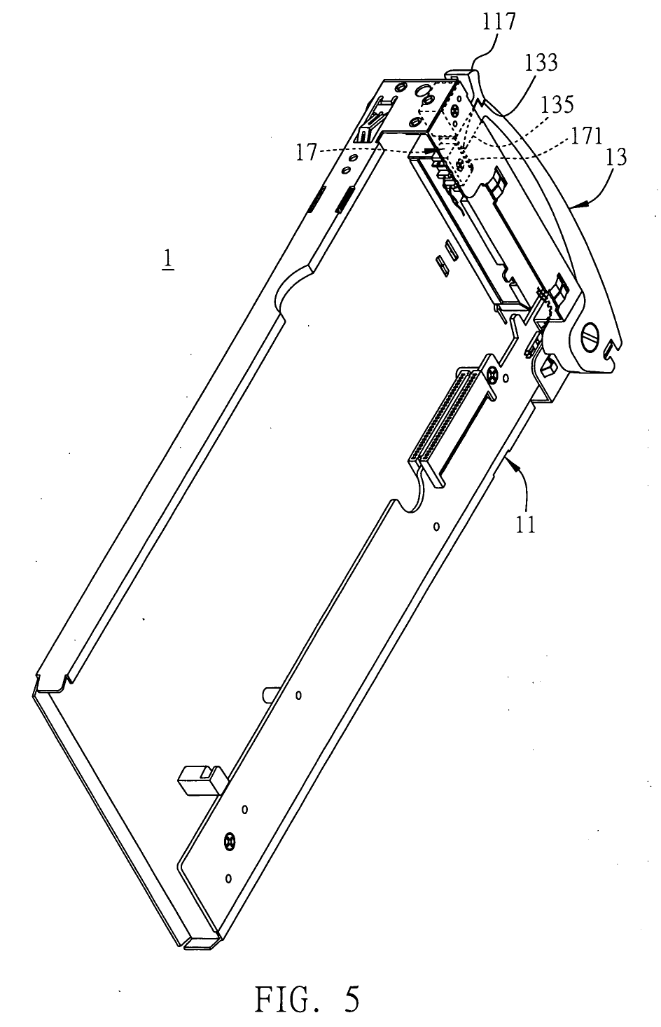

Then, as shown in FIG. 5, the second wedging portion 133 disposed at the other end of the handle 13 matches correspondingly with the first wedging portion 117 disposed at the front side of the blade-type body 11, and the actuator 135 of the handle 13 is actuated to press the switch actuator 173 of the switch 17, thereby the connector 15 is electrically connected to the connector disposed on the rear-board of the mainframe server to start the system operation when the handle 13 is installed in such a position.

On the other hand, in pulling out the blade-type electronic device 1, one may pull the handle 13 to release it from the installed position and the second wedging portion 133 disposed at the other end of the handle 13 disengages from the first wedging portion 117 disposed at the front side of the blade-type body 11, such that the actuator 135 of the handle 13 is relieved from pressing the switch actuator 173 of the switch 17, thereby the connector 15 is disconnected from the connector disposed on the rear-board of the mainframe server to end the system operation.

Accordingly, the switch 17 is utilized for controlling on/off electrical signals of the blade-type body 11. In short, the switch 17 is actuated to be in an on state when the handle 13 is in the installed position and in an off state when the handle 13 is released from the installed position.

Compared to prior art techniques, the present invention requires only provision of a control switch that is compliant with the existing structure to control on/off electrical signals of the blade-type electronic device, allowing a user to connect or disconnect the blade-type electronic device without having to turn off power. Thus, the present invention offers advantages over prior art in that it is hot-swappable to prevent incidents of a computer crash or damages to the system due to user's ignorance. Moreover, the user can be properly aware of the system operational status, thereby allowing the user to operate and use the device safely.

It will be understood that the above description of the present invention is susceptible to various modifications, changes, and adaptations, and such similar versions are intended to be comprehended within the meaning and range of equivalents of the appended claims.

What is claimed is:

1. A blade-type electronic device, comprising:
a blade-type body;
a handle provided on one side of the blade-type body to assist in installation of the blade-type electronic device;
a connector disposed on one side of the blade-type body to provide for electrical connection with an external device; and,
a switch disposed inside of the blade-type body and electrically connected to the connector to switch on or off electric signals of the blade-type body, the switch being able to be turned on when the handle is in an installed position.

2. The blade-type electronic device of claim 1, wherein the blade-type body comprises a blade-type casing, an adapter card and an electronic unit.

3. The blade-type electronic device of claim 2, wherein the adapter card is provided at one side of the blade-type casing.

4. The blade-type electronic device of claim 2, wherein the electronic unit is disposed inside of the blade-type casing and can be electrically connected to the adapter card.

5. The blade-type electronic device of claim 1, wherein the blade-type body further comprises a first wedging portion.

6. The blade-type electronic device of claim 5, wherein the handle is provided with a second wedging portion for engaging with the first wedging portion when the handle is in the installed position.

7. The blade-type electronic device of claim 1, wherein the handle comprises a hooking portion and an actuator for actuating the switch.

8. The blade-type electronic device of claim 1, wherein the switch comprises an electrical connector and a switch actuator.

9. The blade-type electronic device of claim 8, wherein the electrical connector is disposed inside of the blade-type body.

10. The blade-type electronic device of claim 8, wherein the switch actuator is fastened at a position inside the blade-type body that can be physically actuated by the handle when being in the installed position.
